(19) United States
(12) Patent Application Publication
(10) Pub. No.: US 2013/0118750 A1
(43) Pub. Date: May 16, 2013

(54) System And Method For Performing Treatments To Provide Multiple Fractures

(71) Applicants: Hongren Gu, Sugar Land, TX (US); Yiyan Chen, Sugar Land, TX (US); Philip F. Sullivan, Bellaire, TX (US)

(72) Inventors: Hongren Gu, Sugar Land, TX (US); Yiyan Chen, Sugar Land, TX (US); Philip F. Sullivan, Bellaire, TX (US)

(21) Appl. No.: 13/296,307

(22) Filed: Nov. 15, 2011

(51) Int. Cl. E21B 43/26; G05D 16/20; G05D 7/06

(52) U.S. Cl. 166/308.1; 700/283

(57) ABSTRACT

A method includes initiating a first hydraulic fracture with a first fracture initiation fluid at a first position in a wellbore. The method further includes positioning a high-solids content fluid (HSCF) in the first hydraulic fracture. The method further includes initiating a second hydraulic fracture with a second fracture initiation fluid at a second position in the wellbore, where the second position is not hydraulically isolated from the first position. The method further includes positioning the HSCF in the second hydraulic fracture.

### BACKGROUND

The technical field generally, but not exclusively, relates to hydraulic fracture stimulation of a horizontal and/or highly deviated well. Providing multiple fracture treatments along a horizontal portion of a wellbore and/or regions of a wellbore where the in-situ formation stresses are of similar magnitudes presents various challenges. Performing complex isolation techniques, either by placement of tools or diversion materials, increases job time and complexity, and introduces the possibility of tool sticking or other operational failures. Accordingly, further technological developments are desirable in this area.

### SUMMARY

One embodiment is a unique system for performing and planning treatments for multiple fractures in a wellbore. Other embodiments include unique methods for performing treatments for providing multiple fractures in a wellbore. This summary is provided to introduce a selection of concepts that are further described below in the illustrative embodiments. This summary is not intended to identify key or essential features of the claimed subject matter, nor is it intended to be used as an aid in limiting the scope of the claimed subject matter. Further embodiments, forms, objects, features, advantages, aspects, and benefits shall become apparent from the following description and drawings.

### BRIEF DESCRIPTION OF THE DRAWINGS

FIG. 1 is a schematic diagram of a system for fracturing multiple zones in a wellbore.

FIG. 2 is a schematic diagram of another system for fracturing multiple zones in a wellbore.

FIG. 3 is a schematic diagram of a processing subsystem for controlling operations for fracturing multiple zones in a wellbore.

### DESCRIPTION OF ILLUSTRATIVE EMBODIMENTS

For the purposes of promoting an understanding of the principles of the application, reference will now be made to the embodiments illustrated in the drawings and specific language will be used to describe the same. It will nevertheless be understood that no limitation of the scope of the application is thereby intended, any alterations and further modifications in the illustrated embodiments, and any further applications of the principles of the application as illustrated therein as would normally occur to one skilled in the art to which the application relates are contemplated herein.

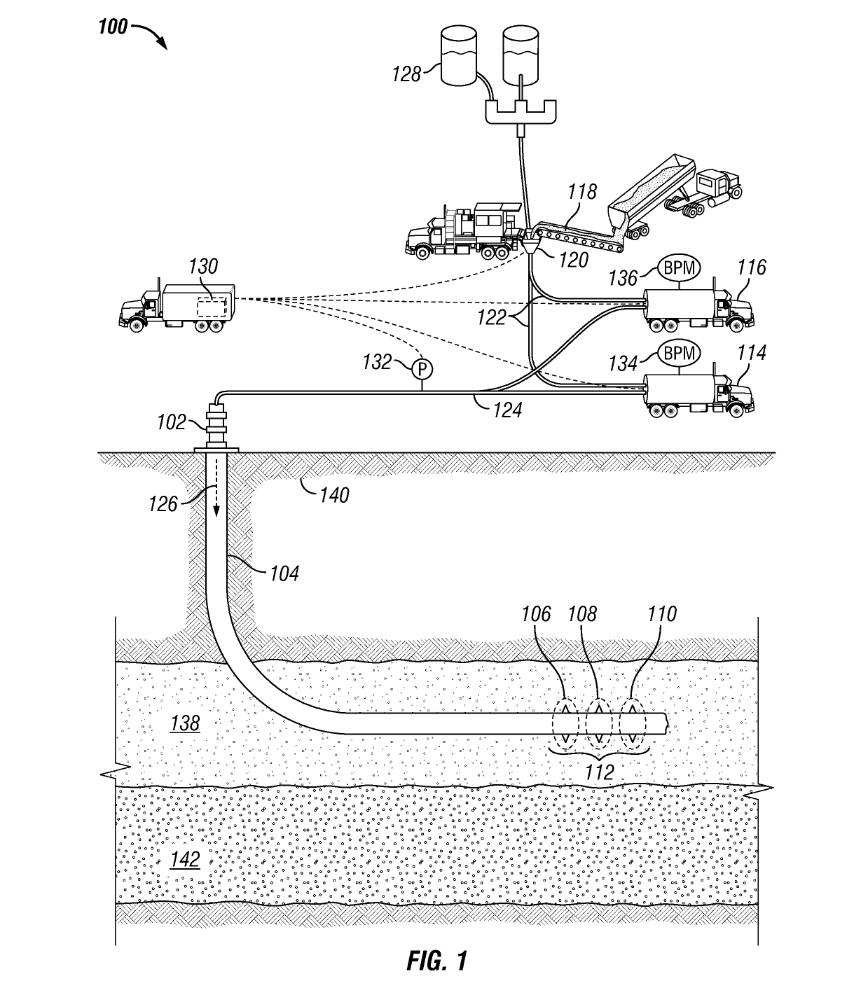

Referencing FIG. 1, a system 100 for fracturing multiple zones in a wellbore is depicted. Various elements of the system 100 may not be present in certain embodiments of the present disclosure. The system 100 includes a wellhead 102 providing fluid communication between surface equipment and a wellbore 104. The system 100 further includes a horizontal portion 112 of the wellbore 104, divided for conceptual purposes into various zones 106, 108, 110. In certain embodiments, stimulation of the horizontal portion 112 of the wellbore 104 includes multiple fractures along a region of interest. The illustration of FIG. 1 shows perforations providing fluid communication between the wellbore 104 and the zones 106, 108, 110. In certain embodiments, the wellbore 104 may be an open hole completion or any other type of completion providing fluid communication between the wellbore 104 and the formation of interest 138.

The system 100 includes a formation of interest 138, an overburden 140, and a formation 142 below the formation of interest 138. In certain embodiments, the wellbore 104 may be fluidly coupled to two or more regions of interest 138. The wellbore 104 includes a horizontal portion 112, but example wellbores 104 may be deviated, highly deviated, and/or vertical.

The system 100 further includes one or more high pressure pumps 114, 116 as indicated by the pressures and pumping rates expected for a fracturing treatment, as well as any desired surplus pumping capacity. The system 100 further includes a particulate delivery unit 118, for example to deliver proppant or other particles to the fluids to be injected into the wellbore 104. The system 100 further includes a blender 120 that receives base fluid 128, selectably combines the particulates, and provides the low pressure fluid 122 to the high pressure pumps 114, 116.

The system 100 further includes the surface high pressure fluid 124 delivered to the wellhead 102 and to the wellbore 104. The wellbore high pressure fluid 126 flows through the wellbore 104. The system 100 includes a pressure sensor 132 positioned in the example near the wellhead 102. Additionally or alternatively, the pressure sensor 132 may be provided at the discharge of one or more pumps 114, 116, downhole in the wellbore 104, and/or any pressure value in the system 100 may be determined by a provided sensor or by calculating the pressure value from other parameters available in the system 100.

The system 100 further includes rate sensors 134, 136 operationally coupled to the pumps 114, 116. The rate sensors 134, 136 include any type of rate sensing device known in the art, including without limitation stroke counting devices that assume or estimate a volumetric efficiency of the pumps 114, 116 operating as positive displacement devices. Additional or alternative rate sensors may be provided anywhere in the system. The described system 100 is illustrative and non-limiting. Any other arrangement of producing and pumping fluids described herein is contemplated for an example system 100.

The example system 100 includes a controller 130 structured to functionally perform certain operations for fracturing the multiple zones. In certain embodiments, the controller 130 forms a portion of a processing subsystem including one or more computing devices having memory, processing, and communication hardware. The controller 130 may be a single device or a distributed device, and the functions of the controller may be performed by hardware or software. The controller 130 is in communication with any sensors, actuators, i/o devices, and/or other devices that allow the controller 130 to perform any described operations.

In certain embodiments, the controller 130 includes one or more modules structured to functionally execute the operations of the controller 130. In certain embodiments, the controller 130 includes a formation description module, a fracture execution module, and a pump control module. An example formation description module interprets a first fracture initiation pressure and a second fracture initiation pressure. An example fracture execution module provides a number of injection commands. An example pump control module provides a pump command in response to the injection commands. In certain embodiments, the controller 130 further includes an initiation pressure reduction module. An example initiation pressure reduction module provides an initiation pressure reduction command.

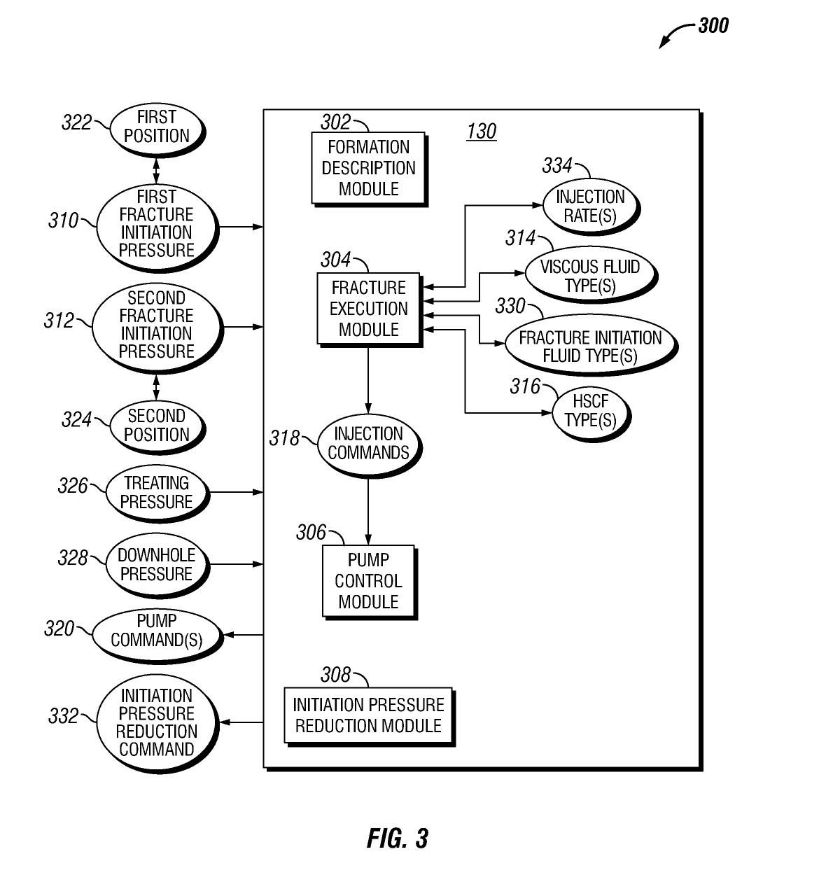

The description herein including modules emphasizes the structural independence of the aspects of the controller 130, and illustrates one grouping of operations and responsibilities of the controller 130. Other groupings that execute similar overall operations are understood within the scope of the present application. Modules may be implemented in hardware and/or software on computer readable medium, and modules may be distributed across various hardware or software components. More specific descriptions of certain embodiments of controller operations are included in the portions of the description referencing FIG. 3.

Certain operations described herein include operations to interpret one or more parameters. Interpreting, as utilized herein, includes receiving values by any method known in the art, including at least receiving values from a datalink or network communication, receiving an electronic signal (e.g. a voltage, frequency, current, or PWM signal) indicative of the value, receiving a software parameter indicative of the value, reading the value from a memory location on a computer readable medium, receiving the value as a run-time parameter by any means known in the art including operator entry, and/or by receiving a value by which the interpreted parameter can be calculated, and/or by referencing a default value that is interpreted to be the parameter value.

Referencing FIG. 3, a processing subsystem 300 includes a controller 130 having an example formation description module 302 that interprets a first fracture initiation pressure 310 and a second fracture initiation pressure 312. The first fracture initiation pressure 310 is a first breakdown pressure within a wellbore 104 where a hydraulic fracture may be initiated. In certain embodiments, the first fracture initiation pressure 310 is associated with a first position 322. In the example of FIG. 1, any one of the wellbore positions 106, 108, 110 may be the first position 322. In certain embodiments, the position of the first fracture initiation pressure 310 is not known, although the first fracture initiation pressure 310 is still known or determinable. In certain embodiments, prior fracturing experience in the area teaches the first fracture initiation pressure 310, but the first fracture initiation pressure 310 may also be determined, without limitation, from certain well logs, from an understanding of the wellbore completion design, by reservoir modeling, from pre-fracture pumping tests, and/or by observing the first fracture initiation pressure 310 during fracture pumping operations.

The second fracture initiation pressure 312 is a next breakdown pressure within the wellbore 104 where a hydraulic fracture may be initiated. The second fracture initiation pressure 312 is determinable according to similar considerations as the first fracture initiation pressure 310. The second fracture initiation pressure 312 may be associated with a second position 324 in the wellbore 104, or may also just be a known or determinable value, as with the first fracture initiation pressure 310.

The example processing subsystem 300 further includes the controller 130 having a fracture execution module 304 that provides a number of injection commands 318. Each injection command 318 includes at least one of a fluid type and/or an injection rate 334. A non-limiting example of an injection command 318 includes a pump schedule or a single stage of a pump schedule. However, an injection rate command 318 can be any incremental adjustment to the fluid or injection rate during the operations, planning, simulation, or post-job simulation of a fracturing operation. Any injection rate 334 may be an injection rate value, such as 30 barrels per minute (bpm), or a value from which an injection rate is determinable, such as a treating pressure target value, a bottomhole pressure target value, and/or a pressure target value at a specified position within the wellbore 104.

In certain embodiments, the fracture execution module 304 provides a first injection command 318 including a first viscous fluid type 314 and a first injection rate 334 that is determined to exceed the first fracture initiation pressure 310. The first injection rate 334 that is determined to exceed the first fracture initiation pressure 310 may be a value specified in advance, determined during pressure observations while pumping, and/or corrected during operations such as in pressure feedback control of the injection rate. In certain embodiments, the viscous fluid type 314 is varied one or more times during the treatment.

A viscous fluid type 314 as utilized herein is any fluid type that includes a viscosity enhancer in any form—including without limitation a polymer or cross-linked polymer, an energized fluid, an emulsified fluid, and/or a fluid having a surfactant added thereto. The viscous fluid type 314 includes sufficient viscosity to generate a fracture having sufficient width that subsequent particles injected into the wellbore 104 can be delivered into the generated fracture. The pump rate, formation stress and mechanical properties, adjacent formation stresses and mechanical properties, fluid leakoff rates, size of particulates to be injected, and other parameters understood to one of skill in the art affect the generated width of the fracture. Accordingly, the viscosity sufficient to be a viscous fluid type 314 is an application specific parameter understood to one of skill in the art having the benefit of the disclosures herein, and specific values cannot be defined generally in advance. The determination of a sufficient viscosity is a mechanical step to one of skill in the art having the benefit of the disclosure herein and parameters ordinarily available for a specific system.

In certain embodiments, a fracture initiation fluid type 330 is provided as the fluid type for the first and third injection commands 318, and/or in any situation where a viscous fluid type 314 is otherwise described herein. A fracture initiation fluid type 330 includes any fluid that is capable of initiating a fracture in the adjacent formation 138 to the wellbore 104. An example fracture initiation fluid type 330 includes a viscous fluid type 314 having sufficient viscosity to provide sufficient fracture width such that the HSCF fluid type 316 can subsequently propagate a fracture. In certain embodiments, the fracture initiation fluid type 330 is a fluid having particles with a size of a sufficiently small magnitude such that the fracture can be initiated and propagated without a screenout. The size of particles that permit fracture initiation is dependent upon formation characteristics that are particular to a specific formation. Alternatively or additionally, a leading portion of the fracture initiation fluid type 330 may be free of particles or have smaller particles, and particles may be introduced or increased in size during the injection of the fracture initiation fluid type 330. In certain embodiments, the fracture initiation fluid type 330, or a portion thereof, may have sufficient particles to also be considered an HSCF. An HSCF can be developed from a fluid having only particles with a small magnitude, particularly but not exclusively when combined with additional particles having an even smaller magnitude.

The example fracture execution module 304 further provides a second injection command 318 including a first high solids content fluid (HSCF) type 316 and a second injection rate 334 that is determined to remain below the second fracture initiation pressure 312. The first injection rate 334 that is determined to exceed the first fracture initiation pressure 310 may be a value specified in advance, determined during pressure observations while pumping, and/or corrected during operations such as in pressure feedback control of the injection rate. Non-limiting example HSCF fluids include a fluid having particles such that a packed volume fraction (PVF) of the fluid exceeds 0.64, a fluid having a PVF exceeding 0.75, a fluid having a PVF exceeding 0.80, a fluid having a PVF exceeding 0.85, a fluid having a PVF exceeding 0.90, and/or a fluid having a PVF exceeding 0.95. HSCF fluids having high PVF values can be generated from a mixture of two or more particle types having distinct size distribution values, and/or from a group of particles having a heterogeneous size distribution over a wide enough size distribution. Certain additional or alternative example HSCF fluids include a fluid having at least two particle types having distinct size distribution values and/or a fluid having at least three particle types having distinct size distribution values. One or more of the particle types may be partially or completely degrading, dissolving, or reactive to formation fluids or introduced chemicals such that the particles disappear or flow back after the fracture treatment is completed.

Yet another example HSCF fluid includes a fluid having a high particle density or proppant density. A proppant density that is high is relative to the formation and application, and any proppant density that is higher than a normal proppant density for the area, formation permeability, or other parameters is contemplated herein. In certain embodiments, without limitation, proppant densities exceeding 6 PPA (pounds proppant added per gallon of carrier fluid), 8 PPA, 10 PPA, and 12 PPA are high proppant densities.

The use of an HSCA fluid provides the HSCA fluid with certain characteristics. One or more of the described characteristics may be present in certain embodiments and not in others. Certain embodiments in accordance with the present disclosure may not include any of the described characteristics and nevertheless are contemplated herein. An example characteristic is that an HSCA fluid provides a relatively high propped fracture volume relative to the hydraulically generated fracture volume, allowing the fracture to have a relatively high conductivity with low fluid leakoff and damage into the formation. Another example characteristic is that an HSCA fluid experiences, in certain formulations, a relatively low particle settling rate, providing for simplified pumping execution in certain operations, for example when alternating between pumping one fluid through tubing and another fluid in a tubing-wellbore annulus. Another example characteristic is that the fluidizing and de-fluidizing nature of an HSCF fluid provides for pressure oscillations during a fracture treatment, allowing a fracture treatment to overcome stress differences of similar magnitude such as those experienced in a horizontal or highly deviated wellbore. Another example characteristic is that, within a fracture, an HSCF fluid can bridge and de-bridge, allowing for pumping operations to be controlled within a treating pressure range (or downhole pressure, specified position pressure, etc.) without the fluid in the fracture experiencing a permanent screenout.

An example fracture execution module 304 further provides a third injection command including a second viscous fluid type 314 and a third injection rate 334 determined to exceed the second fracture initiation pressure 312. The second viscous fluid type 314 may be the same or a different fluid than the first viscous fluid type. The example fracture execution module 304 still further provides a fourth injection command 318 including a second HSCF fluid type 316. The second HSCF fluid type 316 may be the same or a different fluid than the first HSCF fluid type 316. In certain additional embodiments, the fourth injection command 318 further includes a fourth injection rate 334 determined to remain below any additional fracture initiation pressures, such as a third, fourth, or other additional fracture initiation pressure.

The example controller 130 further includes a pump control module that provides a pump command 320 in response to the injection commands 318 (e.g. first, second, third, and fourth). Referencing FIG. 1, the system 100 includes high pressure pumps 114, 116 that are fluidly coupled to the wellbore 104 and responsive to the pump command(s) 320. In certain embodiments, the pump control module 306 directly controls pumps 114, 116, for example electronically. Additionally or alternatively, the pump control module 306 provides the pump commands 320 to a display, network, datalink, or other device external to the controller 130 and usable directly or indirectly for controlling the rate of the pumps 114, 116. In certain embodiments, an injection rate 334 from the injection command 318 is divided in some manner between the pumps 114, 116, and the pump command(s) 320 include a description of the pump rate for each pump 114, 116 determined in any manner to contribute to the total injection rte 334. Example pump commands 320 include electrical signals, network communications, a throttle position, a data display, a verbal description followed by an operator, and/or any other pump command 320 understood in the art.

In certain embodiments, the controller 130 further includes an initiation pressure reduction module 308 that provides an initiation pressure reduction command 332. An example system 100 further includes an initiation pressure reduction device (not shown) that reduces the second fracture initiation pressure 312 in response to the initiation pressure reduction command 332. In certain embodiments, multiple fracture initiation pressures beyond the second fracture initiation pressure 312 may be reduced by one or more initiation pressure reduction devices, for example to facilitate fracturing multiple zones 106, 108, 110 in a predictable sequence. Non-limiting example initiation pressure reduction devices include an oriented perforating device, a shaped charge, an abrasive jet, and/or a high density perforating device. Example initiation pressure reduction commands 332, without limitation, include a display output indicating that a particular fracturing stage is scheduled and/or an electrical, hydraulic, or other signal to a device that operates or communicates intended operation to an initiation pressure reduction device. Any device that reduces the fracture initiation pressure at a selectable location in the wellbore by any method, including at least initiating a near-wellbore fracture, reducing near-wellbore tortuosity, and improving fluid communication between the wellbore and the adjacent formation 138 is contemplated herein.

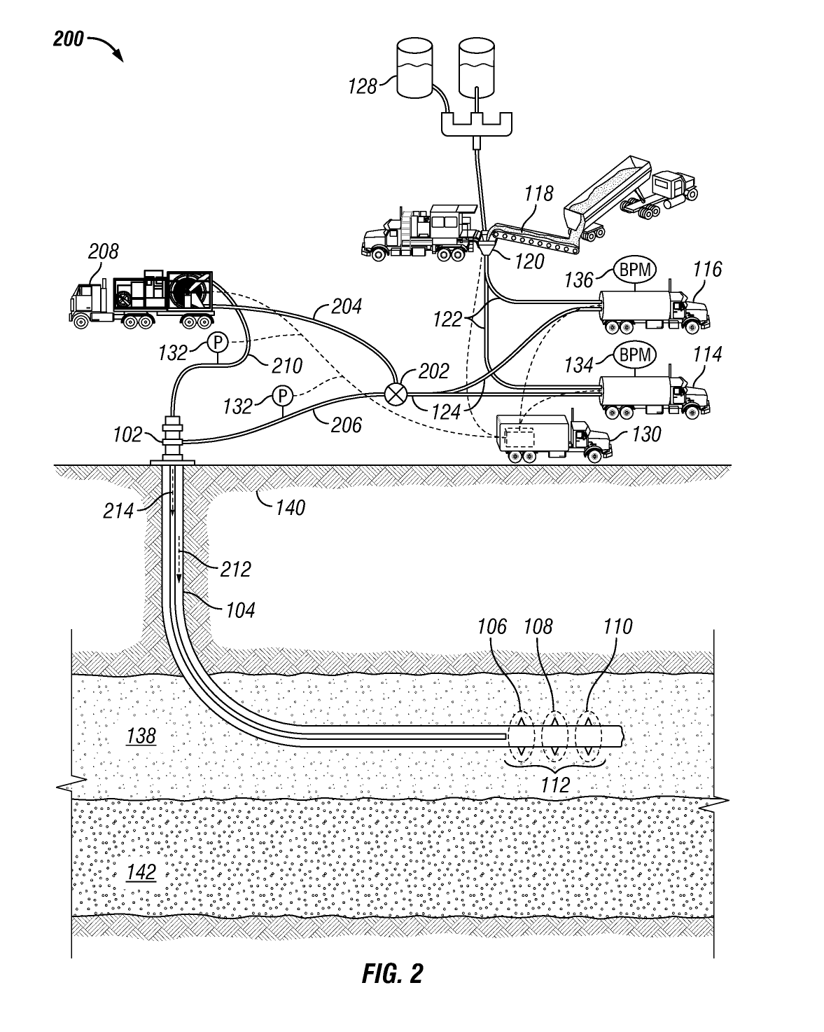

Referencing FIG. 2, another example system 200 is illustrated. In certain embodiments, the example system 200 includes a coiled tubing unit (CTU) 208 fluidly coupled to the wellbore 104. The example system 200 includes one or more high pressure pumps 114, 116 fluidly coupled to the wellbore 104 and responsive to the pump command from the controller 130. In certain embodiments, the high pressure pumps 114, 116 inject the first and second viscous fluid types through the CTU 208, for example as high pressure fluid 214. The high pressure pumps 114, 116 inject the first and second HSCF fluid types through a coiled tubing-wellbore annulus, for example as high pressure fluid 212. In certain further embodiments, the CTU 208 positions the coiled tubing 210 at a first wellbore position (any one of 106, 108, 110 in the example of FIG. 2) before the fracture execution module provides the first injection command, and the CTU 208 positions the coiled tubing 210 at a second wellbore position (any other one of 106, 108, 110) before the fracture execution module provides the third injection command.

In the example of FIG. 2, the system 200 includes a three-way valve 202 that selectably allows the pumps 114, 116 to deliver fluid to the CTU inlet 204 and/or to the annulus inlet 206. Any other pumping arrangement is contemplated herein, including without limitation pumping all fluids through the CTU 208, and/or having a first set of one or more pumps dedicated to pumping through the CTU 208 and a second set of one or more pumps dedicated to pumping through the annulus.

The schematic flow descriptions which follow provide illustrative embodiments of performing procedures for performing multiple fracture operations in a wellbore. Operations illustrated are understood to be examples only, and operations may be combined or divided, and added or removed, as well as re-ordered in whole or part, unless stated explicitly to the contrary herein. Certain operations illustrated may be implemented by a computer executing a computer program product on a computer readable medium, where the computer program product comprises instructions causing the computer to execute one or more of the operations, or to issue commands to other devices to execute one or more of the operations.

A first example procedure includes an operation to inject a first viscous fluid into a wellbore at a downhole treating pressure exceeding a first fracture initiation pressure, an operation to inject a first high solids content fluid (HSCF) into the wellbore, and an operation to maintain the downhole treating pressure below a second fracture initiation pressure until a fracture termination event occurs. Example fracture termination events include, without limitation, a downhole treating pressure exceeding a predetermined pressure value at a predetermined pumping rate, and/or a predetermined volume of the first HSCF being injected. Non-limiting example predetermined pressure values include a value that is determined to be at risk to exceed a fracture initiation pressure for another zone, a value determined to be within a specified margin of being at risk to exceed a fracture initiation pressure for another zone, and/or a pressure value specified for an equipment failure, wear, or maintenance reason. Non-limiting example predetermined pumping rates include a pumping rate determined to be at risk to induce a fracture screenout or failure, a pumping rate determined to be within a specified margin of being at risk to induce a fracture screenout or failure, a pumping rate determined for an equipment capability or stability reason, and/or a pumping rate determined according to a job completion time criteria. Non-limiting example predetermined volumes of the first HSCF include a designed amount of the first HSCF to meet a propped fracture volume criteria and/or a specified amount of the first HSCF according to an amount of fluid and/or particulate material available.

The example procedure further includes an operation to inject a second viscous fluid into the wellbore at a downhole pressure exceeding a second fracture initiation pressure, and an operation to inject a second HSCF fluid into the wellbore. In certain embodiments, the example procedure further includes operations to determine a multiple number of fracture initiation pressures each corresponding to a position in the wellbore, operations to initiate a hydraulic fracture and to position an HSCF into each of the hydraulic fractures in sequence according to the fracture initiation pressures. The procedure includes alternating the viscous fluid and HSCF stages, and sequentially fracturing the various positions in the formation. In certain embodiments, the procedure includes operations to fracture the multiple positions in the formation even where the positions being fractured are not specifically known or identified.

In certain embodiments, the procedure further includes an operation to inject the first viscous fluid and/or he second viscous fluids through a coiled tubing in the wellbore. Additionally or alternatively, the procedure includes an operation to inject the first HSCF and/or the second HSCF through a coiled tubing-wellbore annulus. In certain embodiments, the example procedure includes an operation to move the coiled tubing to a first position corresponding to the first fracture initiation pressure before injecting the first viscous fluid, and an operation to move the coiled tubing to a second position corresponding to the second fracture initiation pressure before injecting the second viscous fluid. A position corresponding to a fracture initiation pressure includes any position in proximity to the position where the fracture initiation pressure is estimated to be applicable, including positions that may be some distance uphole or downhole from the position where the fracture initiation pressure is estimated to be applicable. In certain embodiments, a position that is closer to the position where the fracture initiation pressure is estimated to be applicable than to other positions that are intended to be treated is a position corresponding to the fracture initiation pressure.

In certain embodiments, the procedure includes an operation to reduce the second fracture initiation pressure before the operation to inject the second viscous fluid. An example procedure further includes an operation to reduce the second fracture initiation pressure by an operation to perform an abrasive jet operation and/or by an operation to perform a perforation operation. The perforation operation may include an oriented perforating operation, a high density perforating operation, and/or multiple perforating operations provided at the second position corresponding to the second fracture initiation pressure.

Another example procedure includes an operation to initiate a first hydraulic fracture with a first fracture initiation fluid at a first position in a wellbore, an operation to position a high-solids content fluid (HSCF) in the first hydraulic fracture, and an operation to initiate a second hydraulic fracture with a second fracture initiation fluid at a second position in the wellbore. The second position in the wellbore is in hydraulic communication with the first position in the wellbore. Hydraulic communication indicates that the first position and second position are not hydraulically isolated at the time the second hydraulic fracture initiation occurs, for example with a positive mechanical isolation device. The example procedure further includes an operation to position the HSCF in the second hydraulic fracture. In certain embodiments, the formulation of the HSCF is varied within a specific fracture, and/or between the first and second fracture, although in certain embodiments a consistent HSCF is utilized throughout.

In certain embodiments, each fracturing initiation fluid is a viscous fluid and/or a fluid having a particle size distribution with a small magnitude. In certain embodiments, the example procedure further includes an operation to determine a multiple number of fracture initiation pressures each corresponding to a position in the wellbore, and an operation to initiate a hydraulic fracture and to position an HSCF into each of the hydraulic fractures in sequence according to the fracture initiation pressures. In certain further embodiments, the procedure includes an operation to initiate each hydraulic fracture through coiled tubing and an operation to position the HSCF into each hydraulic fracture through a coiled tubing-wellbore annulus. In still further example embodiments, the procedure includes an operation to move the coiled tubing before each initiating in response to the corresponding position in the wellbore.

Certain embodiments herein of a system for providing multiple fractures for a horizontal and/or deviated well include a means for inducing a treating pressure to exceed a subsequent fracture initiation pressure. Certain non-limiting embodiments of a means for inducing a treating pressure to exceed a subsequent fracture initiation pressure are described as follows. The following descriptions are non-limiting, and do not exclude any other means for inducing a treating pressure to exceed a subsequent fracture initiation pressure described herein.

An example means for inducing a treating pressure to exceed a subsequent fracture initiation pressure includes inducing a bridging/de-bridging behavior in an HSCF fluid positioned within a propagated fracture.

Another example means for inducing a treating pressure to exceed a subsequent fracture initiation pressure includes providing an HSCF fluid having a particle size distribution, including but not limited to a largest particle size and/or a distribution of particles sizes present within the HSCF, structured to bridge at a predetermined operating condition within a first fracture, inducing the treating pressure to exceed a subsequent fracture initiation pressure. The predetermined operating condition includes one or more of a flow rate, a fluid shear rate, a treatment time, a fluid leakoff time period, a treatment temperature, and/or a treatment pressure. For example, a fracture model may determine a fracture width at a predetermined location in the propagated fracture, or a fracture width trajectory along the length of the fracture, and the largest particle size is selected to bridge at the predetermined operating condition utilizing the information from the model. In certain embodiments, the means for inducing a treating pressure to exceed a subsequent fracture initiation pressure includes providing an HSCF fluid having a particle size distribution, including but not limited to a largest particle size, structured to screenout at a predetermined operating condition within a first fracture. In another example, the determination of particle sizes that induce bridging at the predetermined operating conditions is made empirically based upon experience with offset wells or with wells coupled to formations otherwise understood to be similar to the formation of interest.

Another example means for inducing a treating pressure to exceed a subsequent fracture initiation pressure includes providing an HSCF fluid having a chemical formulation structured to bridge at a predetermined operating condition within a first fracture, inducing the treating pressure to exceed a subsequent fracture initiation pressure. The chemical formulation of the HSCF fluid includes any chemical or precursor within the substrate treating fluid and/or within the particles of the HSCF that, at the predetermined operating condition, reacts to induce bridging in the propagated fracture. The chemical formulation of the HSCF fluid may be responsive to operating temperatures, wellbore fluids, downhole pressures, shear within the propagated fracture, chemical precursors that change composition during the treatment, or any other operating parameters understood in the art. The reaction to induce bridging in the formation includes any reaction that is understood to change the properties of the HSCF, including the particles or the substrate fluid, such that bridging is promoted. Non-limiting example reaction effects include reduction in the HSCF effective viscosity, increase in the HSCF leakoff rate, and/or increase in HSCF particle size.

The flow rate, fluid shear rate, treatment time, fluid leakoff time period, treatment temperature and/or treatment pressure are interconnected with the geometry of the fracture, the rheology, particle carrying capacity, and other properties of the treating fluid, and/or the interactions of the particles in the treating fluid with the treating fluid and/or wellbore fluids. Accordingly the bridging and/or screenout can be planned at a predetermined operating condition. The bridging of particles, or particle bridging/unbridging behavior, can be utilized to induce a treating pressure at the bottom hole (or at the second position) to exceed the second fracture initiation pressure. In certain embodiments, the normal pressurization of the first fracture during treatment operations is utilized to induce the treating pressure to exceed the second fracture initiation pressure without designing the first HSCF with a particle size and/or chemical formulation to specifically induce bridging and/or a screenout.

Any of the described means may include inducing a screenout in addition to or instead of bridging. Any of the described predetermined operating conditions may be additionally or alternatively a controlled operating condition. Any controllable operating condition, including without limitation pumping rates, electronic, pneumatic, hydraulic and/or acoustic signals, and/or chemical operations controllable during a treatment operation, are contemplated herein as example operations to inject the second viscous fluid into the wellbore at a downhole pressure exceeding the second fracture initiation pressure.

As is evident from the figures and text presented above, a variety of embodiments according to the present disclosure are contemplated.

An example set of embodiments is a method including injecting a first viscous fluid into a wellbore at a downhole treating pressure exceeding a first fracture initiation pressure, injecting a first high solids content fluid (HSCF) into the wellbore, and maintaining the downhole treating pressure below a second fracture initiation pressure until a fracture termination event occurs. The method further includes injecting a second viscous fluid into the wellbore at a downhole pressure exceeding a second fracture initiation pressure, and injecting a second HSCF fluid into the wellbore.

Certain further embodiments of the example method are described following. An example method includes the fracture termination event being a downhole treating pressure exceeding a predetermined pressure value at a predetermined pumping rate, and/or a predetermined volume of the first HSCF being injected. An example method includes injecting the first viscous fluid and/or the second viscous fluids through a coiled tubing in the wellbore. Additionally or alternatively, the method includes injecting the first HSCF and/or the second HSCF through a coiled tubing-wellbore annulus. In certain embodiments, the example method includes moving the coiled tubing to a first position corresponding to the first fracture initiation pressure before injecting the first viscous fluid, and moving the coiled tubing to a second position corresponding to the second fracture initiation pressure before injecting the second viscous fluid.

In certain embodiments, the method includes reducing the second fracture initiation pressure before the injecting the second viscous fluid. An example method further includes reducing the second fracture initiation pressure by performing an abrasive jet operation and/or performing a perforation operation. The perforation operation may include an oriented perforating operation, a high density perforating operation, and/or multiple perforating operations in provided at the second position corresponding to the second fracture initiation pressure.

Another example method includes injecting the second viscous fluid into the wellbore at a downhole pressure exceeding the second fracture initiation pressure by providing the first HCSF with a predetermined particle size to promote particle bridging and/or a screenout at a predetermined operating condition. Non-limiting example predetermined operating conditions include a flow rate, a fluid shear rate, a treatment time, a fluid leakoff time period, a treatment temperature, and/or a treatment pressure. For example and without limitation, a particle size in the first HCSF (especially, but not exclusively, a largest particle size) may be selected to induce bridging in the first initated fracture at a predetermined operating condition that is determinable according to fracture modeling, experience in offset wells, or according to any other source of information known to one of skill in the art. The promotion of bridging and/or a screenout may be planned at any position of the fracture, including without limitation at the propped extension of the fracture away from the wellbore (e.g. the fracture tip).

Additionally or alternatively, operations to inject the second viscous fluid into the wellbore at a downhole pressure exceeding the second fracture initiation include providing the first HCSF with a predetermined chemical formulation to promote bridging at a predetermined operating condition—for example by providing the first HCSF fluid with a chemical formulation that changes viscosity, leakoff rate, or other properties at a predetermined temperature, fluid shear rate, pressure, etc. Additionally or alternatively, the operations to inject the second viscous fluid into the wellbore at a downhole pressure exceeding the second fracture initiation include providing the first HCSF with a predetermined particle size and/or chemical formulation to promote bridging and/or a screenout at a controllable operation condition. Any controllable operating condition, including without limitation pumping rates, electronic, pneumatic, hydraulic and/or acoustic signals, chemical operations controllable during a treatment operation, are contemplated herein as example operations to inject the second viscous fluid into the wellbore at a downhole pressure exceeding the second fracture initiation pressure.

An example method includes fracturing multiple zones in sequence. In certain embodiments, each HCSF may include a predetermined particle size and/or chemical formulation to promote bridging and/or a screenout in each fracture, thereby providing for the downhole treating pressure to exceed a subsequent fracture initiation pressure.

Another example set of embodiments is a system for fracturing multiple zones intersecting a wellbore. An example system includes a controller structured to functionally perform certain operation for fracturing the multiple zones. An example controller includes a formation description module, a fracture execution module, and a pump control module. In certain embodiments, the system further includes an initiation pressure reduction module.

An example formation description module interprets a first fracture initiation pressure and a second fracture initiation pressure. An example fracture execution module provides a number of injection commands. In certain embodiments, the fracture execution module provides a first injection command including a first viscous fluid type and a first injection rate that is determined to exceed the first fracture initiation pressure. The fracture execution module further provides a second injection command including a first high solids content fluid (HSCF) type and a second injection rate that is determined to remain below the second fracture initiation pressure. The fracture execution module further provides a third injection command including a second viscous fluid type and a third injection rate determined to exceed the second fracture initiation pressure. The example fracture execution module still further provides a fourth injection command including a second HSCF fluid type. In certain additional embodiments, the fourth injection command further includes a fourth injection rate determined to remain below any additional fracture initiation pressures.

The example controller further includes a pump control module that provides a pump command in response to the first injection command, the second injection command, the third injection command, and the fourth injection command. In certain further embodiments, the system includes at least one high pressure pump fluidly coupled to a wellbore and responsive to the pump command. In certain embodiments, the system includes the wellbore being a horizontal wellbore, and/or a highly deviated wellbore.

In certain embodiments, the example system includes a coiled tubing unit (CTU) fluidly coupled to a wellbore, and one or more high pressure pumps fluidly coupled to the wellbore and responsive to the pump command. In certain embodiments, the high pressure pumps inject the first and second viscous fluid types through the CTU, and inject the first and second HSCF fluid types through a coiled tubing-wellbore annulus. In certain further embodiments, the CTU positions the coiled tubing at a first wellbore position before the fracture execution module provides the first injection command, and the CTU positions the coiled tubing at a second wellbore position before the fracture execution module provides the third injection command.

In certain embodiments of the example system, the first fracture initiation pressure corresponds to a first position in the wellbore and the second fracture initiation pressure corresponds to a second position in the wellbore. The example system further includes an initiation pressure reduction module that provides an initiation pressure reduction command, and an initiation pressure reduction device that reduces the second fracture initiation pressure in response to the initiation pressure reduction command. Non-limiting example initiation pressure reduction devices include an oriented perforating device, a shaped charge, an abrasive jet, and/or a high density perforating device.

In certain embodiments, the HSCF comprises a fluid having a packed volume fraction (PVF) exceeding 0.64, a fluid having a PVF exceeding 0.75, a fluid having a PVF exceeding 0.80, a fluid having a PVF exceeding 0.85, a fluid having a PVF exceeding 0.90, a fluid having a PVF exceeding 0.95, a fluid having at least two particle types having distinct size distribution values, a fluid having at least three particle types having distinct size distribution values, and/or a fluid having a high proppant density.

Yet another example of a set of embodiments is a method including initiating a first hydraulic fracture with a first fracture initiation fluid at a first position in a wellbore, positioning a high-solids content fluid (HSCF) in the first hydraulic fracture, and initiating a second hydraulic fracture with a second fracture initiation fluid at a second position in the wellbore. The second position in the wellbore is in hydraulic communication with the first position in the wellbore. The example method further includes positioning the HSCF in the second hydraulic fracture.

In certain embodiments, each fracturing initiation fluid is a viscous fluid and/or a fluid having a particle size distribution with a small magnitude. In certain embodiments, the example method further includes determining a multiple number of fracture initiation pressures each corresponding to a position in the wellbore, and initiating a hydraulic fracture and positioning an HSCF into each of the hydraulic fractures in sequence according to the fracture initiation pressures. In certain further embodiments, the method includes initiating each hydraulic fracture through coiled tubing and positioning the HSCF into each hydraulic fracture through a coiled tubing-wellbore annulus. In still further example embodiments, the method includes moving the coiled tubing before each initiating in response to the corresponding position in the wellbore.

Yet another example set of embodiments is a method including initiating a first hydraulic fracture with a first fracture initiation fluid at a first position in a wellbore, positioning a high-solids content fluid (HSCF) in the first hydraulic fracture, and initiating a second hydraulic fracture with a second fracture initiation fluid at a second position in the wellbore. The second position is in hydraulic communication with the first position. The method further includes positioning the HSCF in the second hydraulic fracture.

An example method further includes each fracturing initiation fluid being a viscous fluid. In certain further embodiments, the operation to position the HSCF in the first hydraulic fracture further includes injecting the HSCF into the wellbore, and maintaining the downhole treating pressure below a second fracture initiation pressure until a fracture termination event occurs. Example fracture termination events include the downhole treating pressure exceeding a predetermined pressure value at a predetermined pumping rate, and/or a predetermined volume of the HSCF being injected. Certain additional or alternative embodiments include reducing the second fracture initiation pressure before the injecting the second fracture initiation fluid. Example operations to reduce the second fracture initiation fluid include performing an abrasive jet operation and/or performing a perforation operation.

Example methods further include the initiating a second hydraulic fracture by providing the HCSF positioned in the first hydraulic fracture with a predetermined particle size to promote bridging at a predetermined operating condition, by providing the HCSF positioned in the first hydraulic fracture with a predetermined particle size to promote a screenout at a predetermined operating condition, by providing the HCSF positioned in the first hydraulic fracture with a predetermined particle size to promote bridging at a controllable operating condition, and/or by providing the HCSF positioned in the first hydraulic fracture with a predetermined particle size to promote a screenout at a controllable operating condition. In certain additional or alternative embodiments, the method includes initiating a second hydraulic fracture by providing the HCSF positioned in the first hydraulic fracture with a predetermined chemical formulation to promote bridging at a predetermined operating condition, by providing the HCSF positioned in the first hydraulic fracture with a predetermined chemical formulation to promote a screenout at a predetermined operating condition, by providing the HCSF positioned in the first hydraulic fracture with a predetermined chemical formulation to promote bridging at a controllable operating condition, and/or by providing the HCSF positioned in the first hydraulic fracture with a predetermined chemical formulation to promote a screenout at a controllable operating condition.

In certain embodiments, the method includes determining a multiple number of fracture initiation pressures each corresponding to a position in the wellbore, and initiating a hydraulic fracture and positioning an HSCF into each of the hydraulic fractures in sequence according to the fracture initiation pressures. Additionally or alternatively, the method includes initiating each hydraulic fracture through coiled tubing and positioning the HSCF into each hydraulic fracture through a coiled tubing-wellbore annulus. In certain further embodiments, the method includes moving the coiled tubing before each initiating in response to the corresponding position in the wellbore.

While the application has been illustrated and described in detail in the drawings and foregoing description, the same is to be considered as illustrative and not restrictive in character, it being understood that only certain example embodiments have been shown and described. Those skilled in the art will appreciate that many modifications are possible in the example embodiments without materially departing from the application. Accordingly, all such modifications are intended to be included within the scope of this disclosure as defined in the following claims.

In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112, paragraph 6 for any limitations of any of the claims herein, except for those in which the claim expressly uses the words ‘means for’ together with an associated function.

What is claimed is:

1. A method, comprising:
injecting a first viscous fluid into a wellbore at a downhole treating pressure exceeding a first fracture initiation pressure;
injecting a first high solids content fluid (HSCF) into the wellbore, maintaining the downhole treating pressure below a second fracture initiation pressure until a fracture termination event occurs;
injecting a second viscous fluid into the wellbore at a downhole pressure exceeding a second fracture initiation pressure; and
injecting a second HSCF fluid into the wellbore.

2. The method of claim 1, wherein the fracture termination event comprises one of the downhole treating pressure exceeding a predetermined pressure value at a predetermined pumping rate and a predetermined volume of the first HSCF is injected.

3. The method of claim 1, wherein the injecting the first viscous fluid and injecting the second viscous fluid comprises injecting the first viscous fluid and injecting the second viscous fluid through a coiled tubing disposed in the wellbore.

4. The method of claim 3, further comprising moving the coiled tubing to a first position corresponding to the first fracture initiation pressure before the injecting the first viscous fluid, and moving the coiled tubing to a second position corresponding to the second fracture initiation pressure before the injecting the second viscous fluid.

5. The method of claim 3, wherein the injecting the first HSCF comprises injecting the first HSCF through a coiled tubing-wellbore annulus, and wherein the injecting the second HSCF comprises injecting the second HSCF through the coiled tubing-wellbore annulus.

6. The method of claim 1, further comprising reducing the second fracture initiation pressure before the injecting the second viscous fluid.

7. The method of claim 6, wherein the reducing comprises one of performing an abrasive jet operation and performing a perforation operation.

8. The method of claim 1, wherein the injecting the second viscous fluid into the wellbore at the downhole pressure exceeding the second fracture initiation pressure comprises at least one operation selected from the operations consisting of: providing the first HCSF with a predetermined particle size to promote bridging at a predetermined operating condition, providing the first HCSF with a predetermined chemical formulation to promote bridging at a predetermined operating condition, providing the first HCSF with a predetermined particle size to promote a screenout at a predetermined operating condition, providing the first HCSF with a predetermined chemical formulation to promote a screenout at a predetermined operating condition, providing the first HCSF with a predetermined particle size to promote bridging at a controllable operating condition, providing the first HCSF with a predetermined chemical formulation to promote bridging at a controllable operating condition, providing the first HCSF with a predetermined particle size to promote a screenout at a controllable operating condition, and providing the first HCSF with a predetermined chemical formulation to promote a screenout at a controllable operating condition.

9. A system, comprising:
a controller comprising:
a formation description module structured to interpret a first fracture initiation pressure and a second fracture initiation pressure;
a fracture execution module structured to provide a first injection command comprising a first viscous fluid type and a first injection rate structured to exceed the first fracture initiation pressure, a second injection command comprising a first high solids content fluid (HSCF) type and a second injection rate structured to remain below the second fracture initiation pressure, a third injection command comprising a second viscous fluid type and a third injection rate structured to exceed the second fracture initiation pressure, and a fourth injection command comprising a second HSCF fluid type; and
a pump control module structured to provide a pump command in response to the first injection command, the second injection command, the third injection command, and the fourth injection command.

10. The system of claim 9, further comprising a coiled tubing unit (CTU) fluidly coupled to a wellbore, at least one high pressure pump fluidly coupled to the wellbore and responsive to the pump command, wherein the at least one high pressure pump injects the first and second viscous fluid types through the CTU and injects the first and second HSCF fluid types through a coiled tubing-wellbore annulus.

11. The system of claim 10, wherein the CTU is structured to position the coiled tubing at a first wellbore position before the fracture execution module provides the first injection command, and at a second wellbore position before the fracture execution module provides the third injection command.

12. The system of claim 9, further comprising at least one high pressure pump fluidly coupled to a wellbore and responsive to the pump command.

13. The system of claim 12, wherein the wellbore is one of horizontal and highly deviated.

14. The system of claim 12, wherein the first fracture initiation pressure corresponds to a first position in the wellbore and wherein the second fracture initiation pressure corresponds to a second position in the wellbore, the system further comprising an initiation pressure reduction module structured to provide an initiation pressure reduction command, and an initiation pressure reduction device structured to reduce the second fracture initiation pressure in response to the initiation pressure reduction command.

15. The system of claim 14, wherein the initiation pressure reduction device comprises at least one device selected from the group of devices consisting of an oriented perforating device, a shaped charge, an abrasive jet, and a high density perforating device.

16. The system of claim 9, wherein the HSCF comprises at least one fluid selected from the fluids consisting of a fluid having a packed volume fraction (PVF) exceeding 0.64, a fluid having a PVF exceeding 0.75, a fluid having a PVF exceeding 0.80, a fluid having a PVF exceeding 0.85, a fluid having a PVF exceeding 0.90, a fluid having a PVF exceeding 0.95, a fluid having at least two particle types having distinct size distribution values, a fluid having at least three particle types having distinct size distribution values, and a fluid having a high proppant density.

17. The system of claim 9, further comprising a means for inducing a treating pressure to exceed the second fracture initiation pressure.

18. A method, comprising:
initiating a first hydraulic fracture with a first fracture initiation fluid at a first position in a wellbore;
positioning a high-solids content fluid (HSCF) in the first hydraulic fracture;
initiating a second hydraulic fracture with a second fracture initiation fluid at a second position in the wellbore, wherein the second position is in hydraulic communication with the first position; and
positioning the HSCF in the second hydraulic fracture.

19. The method of claim 18, wherein each fracturing initiation fluid comprises one of a viscous fluid and a fluid having a particle size distribution with a small magnitude.

20. The method of claim 18, further comprising determining a multiple number of fracture initiation pressures each corresponding to a position in the wellbore, and initiating a hydraulic fracture and positioning an HSCF into each of the hydraulic fractures in sequence according to the fracture initiation pressures.

21. The method of claim 20, further comprising initiating each hydraulic fracture through coiled tubing and positioning the HSCF into each hydraulic fracture through a coiled tubing-wellbore annulus.

22. The method of claim 20, further comprising moving the coiled tubing before each initiating in response to the corresponding position in the wellbore.
